(19) United States
(12) Patent Application Publication
(10) Pub. No.: US 2011/0125427 A1
(43) Pub. Date: May 26, 2011

(54) METHOD FOR ESTIMATING EXHAUST MANIFOLD PRESSURE

(75) Inventors: Manuel TUGNOLO, Collegno (IT); Alessandro CATANESE, Orbassano (IT); Simone BARBERO, Torino (IT)

(73) Assignee: GM GLOBAL TECHNOLOGY OPERATIONS, INC., Detroit, MI (US)

(21) Appl. No.: 12/877,920

(22) Filed: Sep. 8, 2010

(30) Foreign Application Priority Data
Sep. 9, 2009 (GB) 0915741.3

(51) Int. Cl. G06F 19/00; G01L 7/00; G01L 27/00

(52) U.S. Cl. 702/50; 702/98

(57) ABSTRACT

A method is provided for estimating a pressure in an exhaust manifold of an internal combustion engine, the internal combustion engine having a combustion chamber with an associated exhaust valve, the method includes, but is not limited to acquiring pressure values within the combustion chamber during an acquisition period (AP) chosen within the time interval when the exhaust valve is open, and averaging the pressure values to obtain a single pressure value which is representative for the pressure in the exhaust manifold.

### CROSS-REFERENCE TO RELATED APPLICATION

This application claims priority to British Patent Application No. 0915741.3, filed Sep. 9, 2009, which is incorporated herein by reference in its entirety.

### TECHNICAL FIELD

The present invention relates to the control of a four strokes I.C. engine operation by the acquisition of some engine operating parameters. More specifically the present invention relates to the control of turbocharged Diesel engines, in which it is very important to know the combustion chamber pressure and the exhaust manifold pressure.

### BACKGROUND

A four strokes internal combustion engine generally comprises at least one cylinder in which a combustion chamber is individually defined by a reciprocating piston. Each combustion chamber is connected by a runner to an intake manifold and by a runner to an exhaust manifold, the runners corresponding in number to the number of individual cylinders of the engine. In each cylinder at least one intake valve and at least one exhaust valve are provided for cyclically opening the combustion chamber towards the intake manifold, for receiving fresh airflow, and respectively to open the combustion chamber towards the exhaust manifold, for discharging the exhaust gas.

The exhaust manifold pressure is an important parameter in controlling many systems of the engine, for example in controlling the turbo-charging system and the EGR (Exhaust Gas Recirculating) system. The exhaust manifold pressure is actually measured by means of a dedicated pressure sensor, which is mounted directly into the exhaust manifold.

Advanced internal combustion engines are equipped with one or more in-cylinder pressure sensor (CPS) which directly measures the pressure within respective combustion chambers, for providing information on the current combustion process. Such advanced internal combustion engines can be equipped with one CPS per each combustion chamber, one CPS per cylinder bank or one CPS per engine.

At least part of the scope of the present invention is to eliminate the exhaust manifold pressure sensor to reduce the cost on the engine. Another scope of the present invention is to meet the goal with a simple, rational and inexpensive solution. In addition, other desirable features and characteristics will become apparent from the subsequent summary and detailed description, and the appended claims, taken in conjunction with the accompanying drawings and this background.

### SUMMARY

Embodiments of the invention provides a method for estimating a pressure in an exhaust manifold of an internal combustion engine having at least a combustion chamber with an associated exhaust valve. The method comprises acquiring pressure values within said combustion chamber during an acquisition period (AP) chosen within the time interval when the exhaust valve is open, and averaging the pressure values to obtain a single pressure value which is representative for the pressure in the exhaust manifold.

When the exhaust valve opens, the combustion chamber directly communicates with the exhaust manifold, while it is isolated from the intake manifold because the intake valve is closed. The exhaust gas initially flows through the valve and the exhaust runner to thereby reaching the exhaust manifold, such that the pressure within the combustion chamber rapidly decreases. After this transient phase, the pressure within the combustion chamber stabilizes.

Through properly selecting the acquisition period, it is possible to measure the average pressure value in this steady phase after exhaust valve opening. The acquisition period is typically defined in term of crank angles, which correspond to linear positions of the piston within the cylinder. More precisely, the acquisition period AP is defined by characteristic dimensions comprising at least two of the following: start of period (SOP), period length (PL), end of period (EOP).

Preferably, the acquisition period lies within the time interval during which the piston exhaust stroke takes place, i.e. between the bottom dead center and the top dead center. More precisely the acquisition period AP is comprised between the exhaust valve opening EVO and the exhaust valve closing EVC.

The characteristic dimensions of the acquisition period can be constant under all engine operating conditions and can comprise all the interval between the EVO and the EVC, or can be calibrated in real time in response to one or more engine measured operating parameters, such as engine load and/or engine speed.

Calibration of the acquisition period AP comprises the calibration of at least one of the above cited characteristic dimensions of the acquisition period AP. Since the combustion chamber directly communicates with the exhaust manifold, the average pressure in the combustion chamber during the mentioned steady phase is in close relation with the pressure in the exhaust manifold.

The pressure within the combustion chamber is substantially equal to the pressure in the exhaust manifold, except for the pressure drop across the exhaust valve and through the exhaust runner. Under certain conditions, depending on the exhaust system geometry and/or on the engine operating conditions, the pressure drop is very small and can be disregarded. Under other conditions, the pressure drop can be higher and it is preferable to keep it into consideration.

Accordingly, a preferred embodiment of the invention further provides to estimate the pressure drop across the exhaust valve and through the exhaust runner associated with the exhaust manifold, and to correct the single pressure value, which is representative for the pressure in the exhaust manifold, by using said pressure drop.

The pressure drop estimation can be provided through a calibration function or a map which correlates the pressure drop value with one or more engine operating parameters, such as engine speed and/or engine load. Such a calibration function or map can be obtained through a geometrical model of the exhaust valve and exhaust runner.

If the engine comprises at least two combustion chambers, the method provides to measure the pressure of each combustion chamber, whereby only the pressure values of a selected combustion chamber are used for averaging such that an average pressure value for the selected combustion chamber is obtained; said average pressure values of the combustion chambers are averaged to obtain a single pressure value which is representative for the pressure in the exhaust manifold. This reference pressure value is generally more significant than the average pressure value of a single combustion chamber.

In accordance with what has been said before, the method further comprises the steps of estimating the pressure drop across the exhaust valve and through the exhaust runner associated with the exhaust manifold, and correcting the single pressure value, which is representative for the pressure in the exhaust manifold, by using said pressure drop. The method according to the invention can be realized in the form of a computer program comprising a program-code to carry out all the steps of the method of the invention and in the form of a computer program product comprising means for executing the computer program.

The computer program product comprises, according to a preferred embodiment of the invention, a control apparatus for an IC engine, for example the ECU of the engine, in which the program is stored so that the control apparatus defines the invention in the same way as the method. In this case, when the control apparatus execute the computer pro-gram all the steps of the method according to embodiments of the invention are carried out.

The method according to embodiments of the invention can be also realized in the form of an electromagnetic signal, said signal being modulated to carry a sequence of data bits which rep-resent a computer program to carry out all steps of the method.

Embodiments of the invention further provide an internal combustion engine specially arranged for carrying out the estimation method.

### BRIEF DESCRIPTION OF THE DRAWINGS

The present invention will hereinafter be described in conjunction with the following drawing figures, wherein like numerals denote like elements, and

FIG. 1 is a schematic illustration of a Diesel engine system according to an embodiment of the present invention;

FIG. 2 is a graph illustrating the pressure trace within each combustion chamber of the engine; and

FIG. 3 is a magnified portion of the graph shown in FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

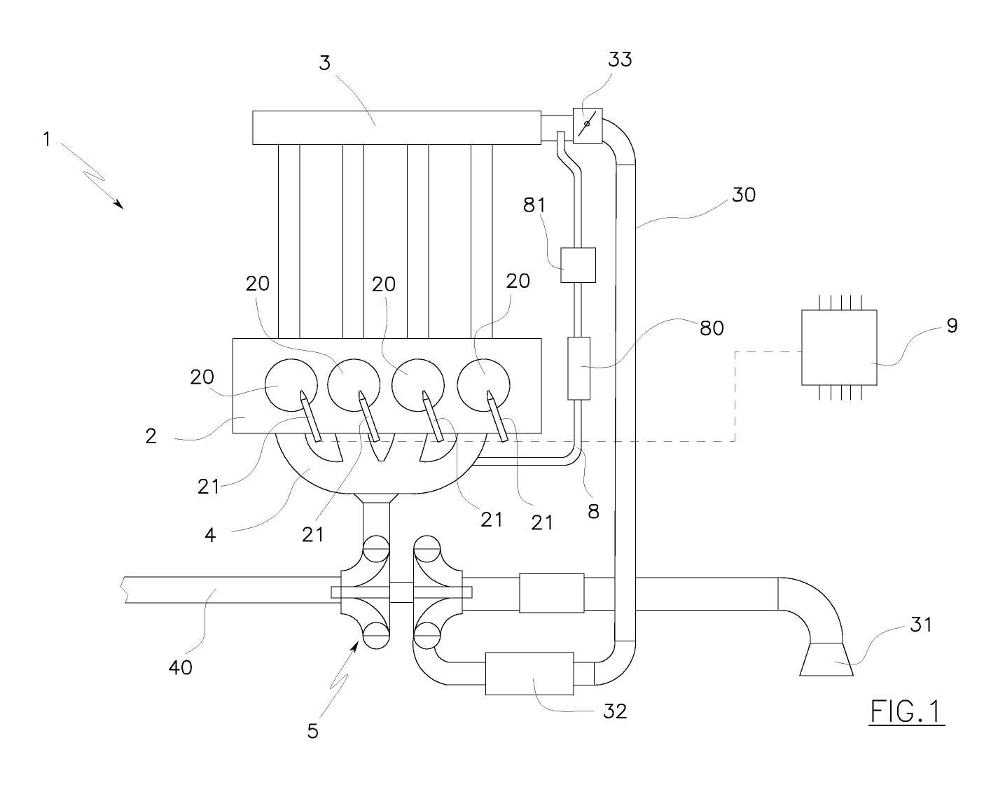

A preferred embodiment of the present invention is applied to a turbocharged diesel engine system, which is generally labeled 1 in FIG. 1. The diesel engine system 1 comprises a four-stroke engine 2 having four combustion chambers 20 which are individually defined by a reciprocating piston inside a cylinder. Each combustion chamber 20 is provided with a respective in-cylinder pressure sensor (CPS) 21, for measuring the pressure within the combustion chamber 20 during engine operation. Each pressure sensor 21 is integrated in a special Glow Plug which protrudes into the respective combustion chamber 20.

The engine 2 further comprises intake manifold 3 and exhaust manifold 4, each of which comprises a plurality of runners corresponding in number to the number of individual combustion chambers 20 of the engine 2. Intake manifold 3 is located at the end of an intake line 30, while the exhaust manifold 4 is located at the beginning of an exhaust line 40. Intake line 30 comprises an inlet 31 for aspirating air at substantially atmospheric pressure. Downstream the inlet 31, a well known turbocharger 5 is located in the intake line 30, for compressing the airflow and for providing it to an intercooler 32. Further downstream, the intake line 30 comprises an intake throttle valve 33 which is electrically controllable for varying the intake restriction. The exhaust gases are expelled from individual combustion chamber 20 of the engine 2 to the corresponding runners and into the exhaust manifold 4.

Exhaust line 40 channels the exhaust gases from the exhaust manifold 4 to drive the turbine of turbocharger 5 and thereafter to atmosphere through an outlet. Between exhaust manifold 4 and turbocharger 5, there is an exhaust gas recirculation line 8, provided with a conventional gas cooler 80 and an exhaust gas recirculation (EGR) valve 81, by means of which a portion of exhaust gas flow is directed to the intake line 30 downstream the throttle valve 33, where it is mixed with the fresh intake airflow to establish the ingested cylinder charge gas mix.

Integral to the engine 2, which in this exemplary embodiment is a diesel engine, is a control system, which comprises sensing means (not shown) for providing respective measures of a plurality of engine operating parameters, such as engine speed and/or engine load, and a micro-processor based controller 9 (ECM), including a computer code for applying the engine operating parameter measures to engine control routines.

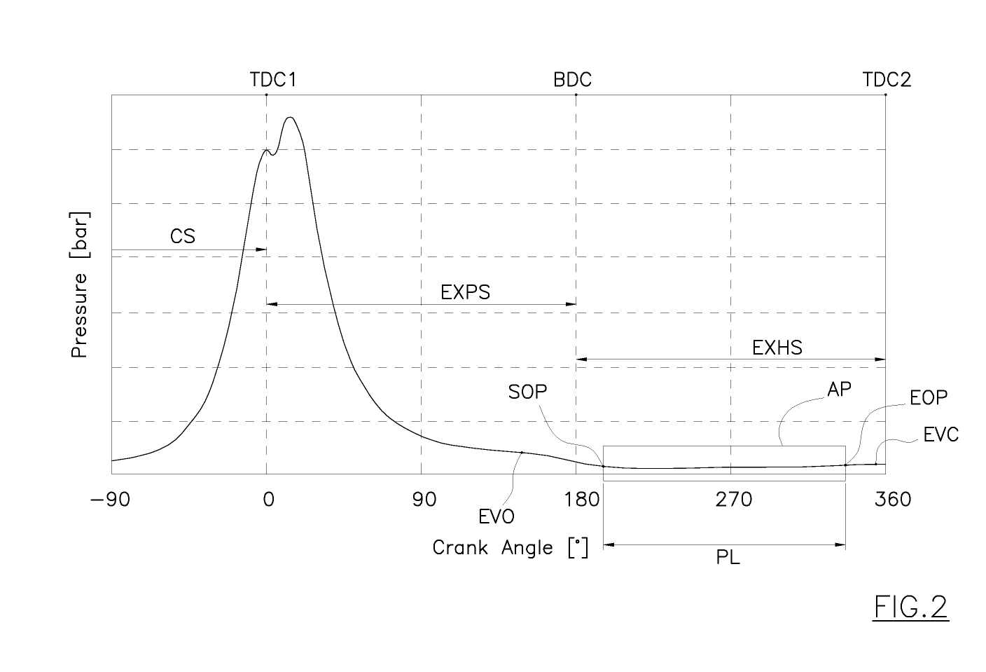

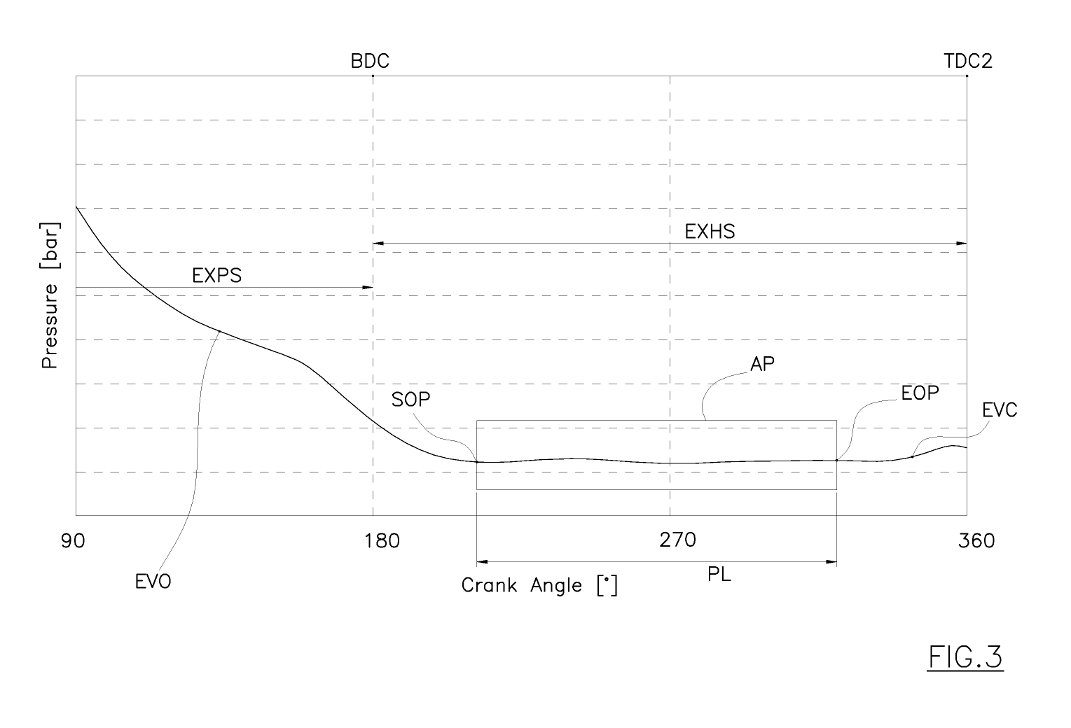

The control system comprises also the already mentioned in-cylinder pressure sensor 21, for measuring the pressure within the combustion chambers 20 during engine operation. The pressure within each combustion chamber 20 varies in relation to the crank angle, according to the trace illustrated in FIG. 2 and FIG. 3. In such figures, reference TDC1 indicates the crank angle corresponding to the piston top dead center position at the end of the compression stroke CS; reference BDC indicates the crank angle corresponding to the piston bottom dead center position at the end of the expansion stroke EXPS; the reference TDC2 indicates the crank angle corresponding to the piston top dead center position at the end of the exhaust stroke EXHS; the reference EVO indicates the crank angle corresponding to the exhaust valve opening after fuel combustion; and reference EVC indicates the crank angle corresponding to the exhaust valve closing.

As can be seen in FIG. 2, the pressure within each combustion chamber 20 increases during compression stroke CS, has a peak immediately after the top dead center TDC1, because of the fuel combustion, and then decreases during the expansion stroke EXPS. When the exhaust valve opens, the combustion chamber 20 directly communicates with the exhaust manifold 4, while it is isolated from the intake manifold 3 because the intake valve is closed. The exhaust gas flows through the exhaust valve and the corresponding exhaust runner, to thereby reaching the exhaust manifold 4.

As can be best seen in FIG. 3, in an initial phase after the exhaust valve opening EVO, the pressure within the combustion chamber 20 rapidly decreases. After this transient phase, the pressure within the combustion chamber 20 stabilizes and remains substantially constant until the exhaust valve closing EVC. Since the combustion chamber 20 directly communicates with the exhaust manifold 4, the pressure within the combustion chamber 20 in this second steady phase is in close relation with the pressure in the exhaust manifold 4.

As a matter of fact, the pressure within the combustion chamber 20 in the steady phase is substantially equal to the pressure in the exhaust manifold 4, except for the pressure drop across the exhaust valve and through the exhaust runner. This pressure drop is because the piston is moving during the exhaust stroke EXHS, such that a little gas flow is always present across the exhaust valve and through the exhaust runner.

Under certain conditions, depending on the exhaust system geometry and/or on the engine operating conditions, the pressure drop is very small and can be disregarded. Under other conditions, the pressure drop can be higher and it is preferable to keep it into consideration.

According to an embodiment of the invention, the pressure within the exhaust manifold 4 is estimated by the controller 9 using the method which is described hereinafter. The controller 9 measures in real time through the respective pressure sensor 21, during engine operation, the pressure value within each combustion chamber 20. As a matter of fact, pressure sensors 21 measure the pressure value within the respective combustion chambers 20 per each rotation angle of the crankshaft. For each combustion chamber 20, the controller 9 selects an acquisition period, which is labeled AP in FIG. 2 and FIG. 3.

The acquisition period AP is comprised between the exhaust valve opening EVO and exhaust valve closing EVC. The acquisition period AP can be defined in term of crank angular positions, which correspond to linear positions of the piston within the cylinder. Preferably, the acquisition period AP is fully located inside the exhaust stroke EXHS, between the bottom dead center BDC and the top dead center TDC. More precisely, the acquisition period AP is defined by the following characteristic dimensions: start of period (SOP), period length (PL), end of period (EOP). Obviously, the acquisition period AP is fully defined by means of only two of the above mentioned characteristic dimensions. The acquisition period AP can be chosen to cover the whole interval between the exhaust valve opening EVO and the exhaust valve closing EVC. Alternatively the acquisition period can be shorter than the interval between EVO an EVC, and can start later and/or before the EVO and the EVC respectively. The acquisition period AP characteristic dimensions can be constant in all engine operating conditions. In this case, the acquisition period AP characteristic dimensions are simply memorized in the controller 9.

Alternatively, the acquisition period AP characteristic dimensions, or at least one of them, can be calibrated in real time by the controller 9 in response to one or more engine operating parameters, such as engine load and/or engine speed. The engine operating parameters are measured by sensors of the control system, and the AP characteristic dimensions are determined by the controller 9 using preset functions or maps which correlate the acquisition period AP characteristic dimensions with the engine operating parameters measures.

The acquisition period AP characteristic dimensions can be equal for all the combustion chambers 20 of the engine 2, or can vary end eventually be calibrated for each combustion chamber 20 independently. It follows that it is possible to have a different acquisition period AP for each combustion chamber 20 and for each engine operating condition. Having established the acquisition period AP, the controller 9 calculates the average pressure value inside the acquisition period AP for each combustion chamber 20. Afterwards, the controller 9 averages said calculated average pressure values among all the combustion chambers 20, to thereby obtaining a single representative pressure value.

According to a preferred embodiment of the invention, the controller 9 further estimates the average pressure drop across the exhaust valves and through the runners. The pressure drop estimation is determined by the controller 9 on the base of one or more engine operating parameters, such as engine speed and/or engine load. The engine operating parameters are measured by the sensors of the control system, and the pressure drop estimation is determined by the controller 9 using a preset calibration function or a map which correlates the pressure drop with the engine operating parameter measures. Such a calibration function or map can be obtained through a geometrical model of the exhaust valves and exhaust runners.

Finally, the controller 9 applies said pressure drop estimation to the previously determined representative pres-sure value, to thereby obtaining exhaust manifold pressure estimation. By way of example, the pressure drop estimation can be defined in term of a coefficient of pressure loss which shall be applied to the representative pressure value, in order to achieve the exhaust manifold pressure estimation.

The method has been tested on a four cylinders 2.0 liters turbocharged Diesel Engine. In this case, a constant acquisition period AP has been selected for all cylinders and for all engine operating conditions. Relative to the exhaust stroke EXHS, the start of such an acquisition period AP was selected at 60° after the bottom dead center BDC, and the end of acquisition period was selected at 140° after the bottom dead center BDC, such that the length of the acquisition period was a range of 80°. The test has demonstrated that, using the method, it is possible to estimate the exhaust manifold pressure with an accuracy of +−5%, if compared to a measure made by a pressure sensor mounted directly within the exhaust manifold 4.

While the present invention has been described with respect to certain preferred embodiments and particular applications, it is understood that the description set forth herein above is to be taken by way of example and not of limitation. Those skilled in the art will recognize various modifications to the particular embodiments are within the scope of the appended claims. Therefore, it is intended that the invention not be limited to the disclosed embodiments, but that it has the full scope permitted by the language of the following claims. The foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for estimating a pressure in an exhaust manifold of an internal combustion engine, the internal combustion engine having a combustion chamber with an exhaust valve, the method comprising the following steps of:
acquiring a plurality of pressure values within said combustion chamber during an acquisition period (AP) chosen within the time interval when the exhaust valve is open; and
averaging the pressure values to obtain a single pressure value that is representative for the pressure in the exhaust manifold.

2. A method according to claim 1 wherein the acquisition period (AP) lies within the time interval during which a piston exhaust stroke takes place.

3. The method according to claim 1 wherein the acquisition period (AP) is defined by a characteristic dimension comprising a start of period (SOP),

4. The method according to claim 3 wherein the characteristic dimension of the acquisition period (AP) are constant under all engine operating conditions.

5. The method according to claim 1, further comprising the steps of:
measuring an engine operating parameter, and
calibrating the acquisition period (AP) dimensions on at least a measured value of said engine operating parameter.

6. The method according to claim 5 wherein the engine operating parameter is an engine speed.

7. The method according to claim 1,
wherein when at least two combustion chambers, the pressure of each combustion chamber is measured,
wherein the pressure values of a selected combustion chamber are used for averaging such that an average pressure value for the selected combustion chamber is obtained, and
wherein a plurality of average pressure values of the at least two combustion chambers are averaged to obtain a single pressure value which is representative for the pressure in the exhaust manifold.

8. The method according to claim 1, further comprising the steps of:
estimating the pressure drop across the exhaust valve and through an exhaust runner associated with the exhaust manifold; and
correcting the single pressure value that is representative for the pressure in the exhaust manifold, by using a pressure drop.

9. The method according to claim 5, further comprising the steps of:
providing a correlation that correlates a pressure drop with an operating parameter; and
applying measured values of said engine operating parameter to said correlation for estimating a exhaust gas pressure drop.

10. The method according to claim 1 wherein the acquisition period (AP) is defined by a characteristic dimension comprising a period length (PL).

11. The method according to claim 1 wherein the acquisition period (AP) is defined by a characteristic dimension comprising an end of period (EOP).

12. The method according to claim 5 wherein the engine operating parameter is an engine load.

13. An internal combustion engine, comprising:
a pressure sensor;
a combustion chamber that is associated with the pressure sensor; and
a controller configured to:
acquiring a plurality of pressure values within said combustion chamber during an acquisition period (AP) chosen within the time interval when an exhaust valve is open; and
averaging the plurality of pressure values to obtain a single pressure value that is representative for a pressure in an exhaust manifold.

14. The internal combustion engine according to claim 13, wherein the acquisition period (AP) lies within the time interval during which a piston exhaust stroke takes place.

15. The internal combustion engine according to claim 13, wherein the acquisition period (AP) is defined by a characteristic dimension comprising a start of period (SOP),

16. The internal combustion engine according to claim 15 wherein the characteristic dimension of the acquisition period (AP) are constant under all engine operating conditions.

17. The internal combustion engine according to claim 13, further comprising the steps of:
measuring an engine operating parameter, and
calibrating the acquisition period (AP) dimensions on at least a measured value of said engine operating parameter.

18. The internal combustion engine according to claim 17, wherein the engine operating parameter is an engine speed.

19. The internal combustion engine according to claim 13,
wherein when at least two combustion chambers, the pressure of each combustion chamber is measured,
wherein the pressure values of a selected combustion chamber are used for averaging such that an average pressure value for the selected combustion chamber is obtained, and
wherein a plurality of average pressure values of the at least two combustion chambers are averaged to obtain a single pressure value which is representative for the pressure in the exhaust manifold.

20. The internal combustion engine according to claim 13, further comprising the steps of:
estimating the pressure drop across the exhaust valve and through an exhaust runner associated with the exhaust manifold; and
correcting the single pressure value that is representative for the pressure in the exhaust manifold, by using said pressure drop.

21. The internal combustion engine according to claim 17, further comprising the steps of:
providing a correlation that correlates the pressure drop with an operating parameter; and
applying measured values of said engine operating parameter to said correlation for estimating a exhaust gas pressure drop.

22. The internal combustion engine according to claim 13, wherein the acquisition period (AP) is defined by a characteristic dimension comprising a period length (PL).

23. The internal combustion engine according to claim 13, wherein the acquisition period (AP) is defined by a characteristic dimension comprising an end of period (EOP).

24. The internal combustion engine according to claim 17, wherein the engine operating parameter is an engine load.

25. A computer readable medium embodying a computer program product, said computer program product, comprising:
a program for estimating a pressure in an exhaust manifold of an internal combustion engine having a combustion chamber with an exhaust valve, the program configured to:
acquire a plurality of pressure values within said combustion chamber (20) during an acquisition period (AP) chosen within the time interval when the exhaust valve is open; and
average the pressure values to obtain a single pressure value that is representative for the pressure in the exhaust manifold.
